(19) United States
(12) Patent Application Publication
(10) Pub. No.: US 2005/0062339 A1
(43) Pub. Date: Mar. 24, 2005

(54) Non-rotating display wheel cover assembly

(75) Inventor: Lisa Marie Fitzgerald, Sarasota, FL (US)

Correspondence Address: Charles J. Prescott, P.A., Suite 115, 2033 Wood Street, Sarasota, FL, 34237, US

(73) Assignee: Leslie Hsiao, Orlando, FL (US)

(21) Appl. No.: 10/665,766

(22) Filed: Sep. 18, 2003

(51) Int. Cl. B60B 27/00

(52) U.S. Cl. 301/108.1

(57) ABSTRACT

A display wheel cover assembly uniquely connectable to, and removable from, a rotatable wheel of a vehicle. This invention includes an adapter plate releasably connectable by unique replacement lug nuts to the outside of the wheel serving as combination spacers and lug nuts. A support bearing member is connected coaxially with a hub of the adapter plate. A wheel cover including a key-actuated locking support having a coaxially extending support shaft is rotatably supported in the support bearing member. An elongated cylindrical locking member is positioned within a longitudinal aperture formed through the support shaft, while a cam member, connected to a distal end of the locking member, has a non-symmetric periphery such that, when properly rotatably orientated, is fully insertable into said support bearing member. In a second rotational orientation, the cam member prevents withdrawal of the support shaft from the support bearing member. A counterweight attached to the wheel cover prevents rotation of the wheel cover. Interchangeable display indicia attach to the wheel cover.

### CROSS-REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates generally to vehicle wheel covers, and more particularly to a commercial display wheel cover including a quick disconnect mechanism permitting convenient wheel lug nut retorqueing and a replaceable display disc which remains substantially stationary with respect to the vehicle while the vehicle is moving.

2. Description of Related Art

The central outer portion of a vehicle wheel, being fully viewable while the vehicle is in motion, provides an opportunity for the placement of readable graphics in this otherwise merely decorative or unornamental portion of the wheel of larger utility vehicles such as buses or trucks. The utilization of this otherwise merely unadorned space is contingent upon the readability of graphics and word messages being held relatively stationary with respect to the vehicle in motion. A number of prior art patented inventions address this display and advertising opportunity.

In U.S. Pat. No. 5,659,989, Hsiao teaches a wheel cover which includes an outer disc member which is rotatably mounted to an inner base member so that the display indicia applied to the disc member will remain substantially rotation free under vehicle movement. This disclosure includes stabilizing structure to maintain alignment and restrict oscillation of the outer disc member bearing the viewable indicia thereon.

Boothe, in U.S. Pat. No. 5,957,542 discloses a theft-proof, non-rotational wheel cover with replaceable ornamental outer surface. This arrangement relies upon and is engageable within the central cavity of the automotive wheel.

Another advertising display device for a vehicle wheel is disclosed by Ryan in U.S. Pat. No. 2,548,070. In this arrangement, however, the device is adapted for attachment to a non-rotatable axle of the motor vehicle.

In U.S. Pat. No. 2,869,262, Lucas teaches another wheel-supported advertising sign arrangement which appears to attach in rotatable fashion to the outer hubcap of the wheel assembly.

In the disclosure of Kovalenko, in U.S. Pat. No. 4,280,293, a stationary display member is attachable to the vehicle hub and utilizes a flowable material such as mercury acting upon veins within a chamber of the device to substantially eliminate rotation of the bearing-mounted outer display member.

A non-rotating wheel cover assembly shown in U.S. Pat. No. 5,588,715 invented by Harlen teaches yet another wheel cover assembly which is attachable to the outer end of an axle by separate bracketry to support the bearing mounted display member. A thickened lower portion of the wheel cover provides sufficient counterbalance to inhibit or prevent rotation of the display cover while the vehicle is in motion.

Matsushita discloses a free wheel cap in U.S. Pat. No. 4,678,239 which teaches a non-rotating wheel cover having a counterbalanced disc-like body which is bearing connected to an inner multi-arm structure having spring-like clips connected at the outer periphery of the device which interengage with the wheel rim.

Another wheel cover was invented by Okamoto and disclosed in U.S. Pat. No. 6,120,104 teaching a flexible side feature connected to the center of the wheel in support of a display wheel cover. An air current guide is formed into the display cover which assists in stabilizing the display portion without substantial rotational movement as the vehicle is moving.

Other prior art devices which teach vehicle wheel display covers are as follows:
U.S. Pat. No. 710,195 to Jones
U.S. Pat. No. 2,014,058 to Tonai
U.S. Pat. No. 2,169,237 to Gasco
U.S. Pat. No. 4,781,419 to Boothe
U.S. Pat. No. 5,190,354 to Levy
U.S. Pat. No. 5,490,342 to Ruterman

U.S. Pat. No. 6,536,848 discloses a display wheel cover which is substantially non-rotating with respect to the vehicle when in motion and which, in a preferred embodiment, utilizes a unique inner member having an elongated hat-shaped section that facilitates attachment to the rim of the wheel by threadably adjustable rim-engaging members that align into the concave groove formed in the outer wheel rim. A unique cam-locking device both retains the outer display wheel cover in place and also prevents its theft removal as a separate security feature requiring a special tool for removal.

### BRIEF SUMMARY OF THE INVENTION

This invention is directed to a display wheel cover assembly uniquely connectable to, and removable from, a rotatable wheel of a vehicle. This invention includes an adapter plate releasably connectable by unique replacement lug nuts to the outside of the wheel serving as combination spacers and lug nuts. A support bearing member is connected coaxially with a hub of the adapter plate. A wheel cover including a key-actuated locking support having a coaxially extending support shaft is rotatably supported in the support bearing member. An elongated cylindrical locking member is positioned within a longitudinal aperture formed through the support shaft, while a cam member, connected to a distal end of the locking member, has a non-symmetric periphery such that, when properly rotatably orientated, is fully insertable into said support bearing member. In a second rotational orientation, the cam member prevents withdrawal of the support shaft from the support-bearing member. A counterweight attached to the wheel cover prevents rotation of the wheel cover. Interchangeable display indicia attach to the wheel cover.

It is therefore a broad object of this invention to provide a non-rotating wheel cover for a commercial utility vehicle or truck which will facilitate the application of decorative and readable commercial display indicia such as in advertising while the vehicle is moving.

It is yet another object of this invention to provide an advertising display cover for the wheel of a commercial vehicle which is easily interchangeable and which is rendered secure from inadvertent or theft removal by a unique locking arrangement.

Still another object of this invention is to provide an advertising display cover for the wheel of a vehicle which receives support from the lugs of the axle of the vehicle through the use of uniquely configured double-duty wheel lug nuts serving as spacers and lug extensions.

Yet another object of this invention is to provide an advertising display cover for the wheels of commercial vehicles which is easily removable to facilitate regular servicing and tightening of the unique lug nuts which hold the wheel onto the axle and also support the wheel cover.

In accordance with these and other objects which will become apparent hereinafter, the instant invention will now be described with reference to the accompanying drawings.

### BRIEF DESCRIPTION OF THE SEVERAL VIEWS OF THE DRAWING(S)

FIG. 1 is an exploded perspective view of one embodiment of the invention shown in conjunction with a wheel of a vehicle.

FIG. 1A is an exploded perspective view of another embodiment for attachment to vehicles having a central axle hub bolt pattern.

FIG. 2 is a front elevation view of the assembled invention shown in FIG. 1 in a locked position absent retainer plate (20) for clarity.

FIG. 3 is a view similar to FIG. 2 in an unlocked position.

FIG. 4 is an enlarged section view in the direction of arrows 4-4 in FIG. 2.

FIG. 5 is an enlarged section view in the direction of arrows 5-5 in FIG. 3.

FIGS. 6 and 8 are front elevation views of the assembled invention of FIG. 1 in the locked and unlocked position, respectively.

FIGS. 7 and 9 are enlargements of areas 7 and 9 of FIGS. 6 and 8, respectively.

FIG. 10 is an exploded perspective view of a universal embodiment of the invention.

FIG. 11 is a cross section view of the assembled embodiment of the invention of FIG. 10.

FIG. 12 is an enlargement of area 12 of FIG. 11.

FIG. 13 is an exploded perspective view of the wheel cover locking support assembly 100 shown in FIG. 10.

FIG. 14 is a front elevation view of FIG. 13 in the locked position.

FIG. 15 is a section view in the direction of arrows 15-15 in FIG. 14.

FIG. 16 is a perspective view of FIG. 15 absent member 102.

FIG. 17 is a front elevation view of FIG. 13 in the unlocked position.

FIG. 18 is a section view in the direction of arrows 18-18 in FIG. 17.

FIG. 19 is a perspective view of FIG. 18 absent member 102.

FIG. 20A is a perspective view of the retainer 68 of FIG. 10.

FIG. 20 is a perspective view of the wheel rim universal adapter plate, and retainer of FIG. 10 in the unlocked orientation.

FIG. 21 is an enlargement of area 21 of FIG. 20.

FIG. 22 is a perspective view of the wheel rim, universal adapter plate, and retainer of FIG. 10 in the locked orientation.

FIG. 23 is an enlargement of area 23 of FIG. 22.

FIG. 24 is a top plan view of a locking key in position for actuating the wheel cover locking support 100 of FIG. 10.

FIG. 25 is a section view in the direction of arrows 25-25 of FIG. 24.

FIG. 26 is a perspective view of FIG. 24.

FIG. 27 is a perspective view of the locking key of FIG. 24.

### DETAILED DESCRIPTION OF THE INVENTION

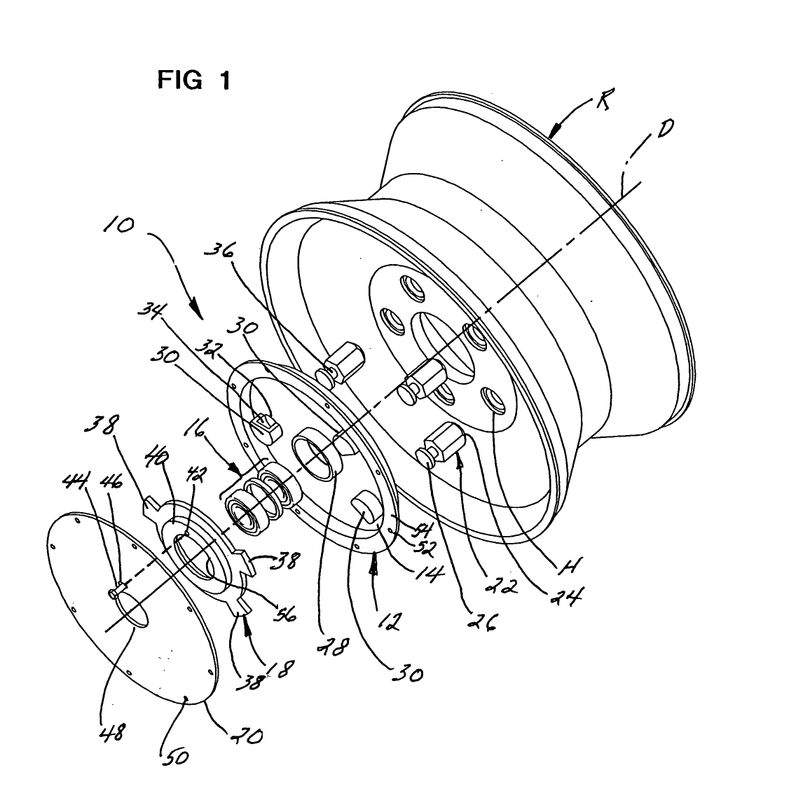

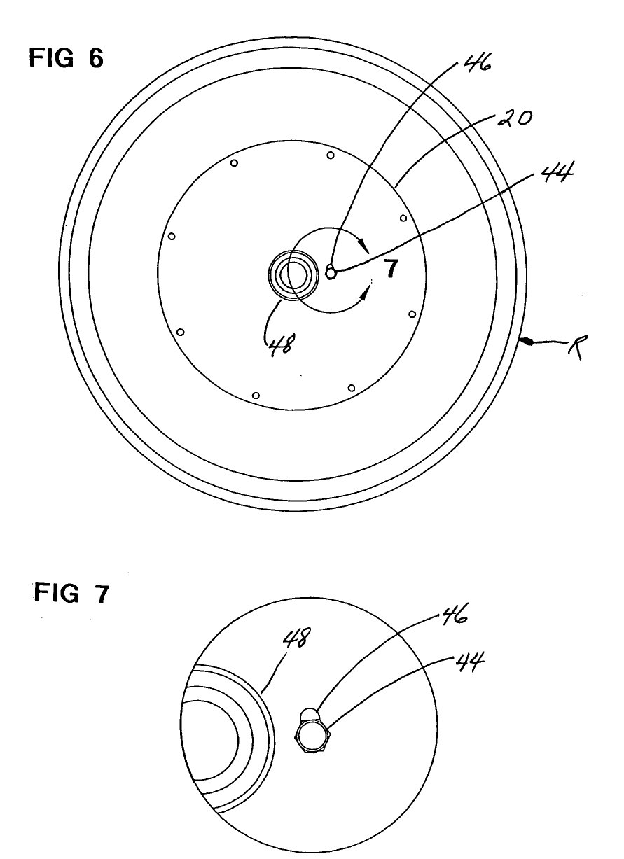

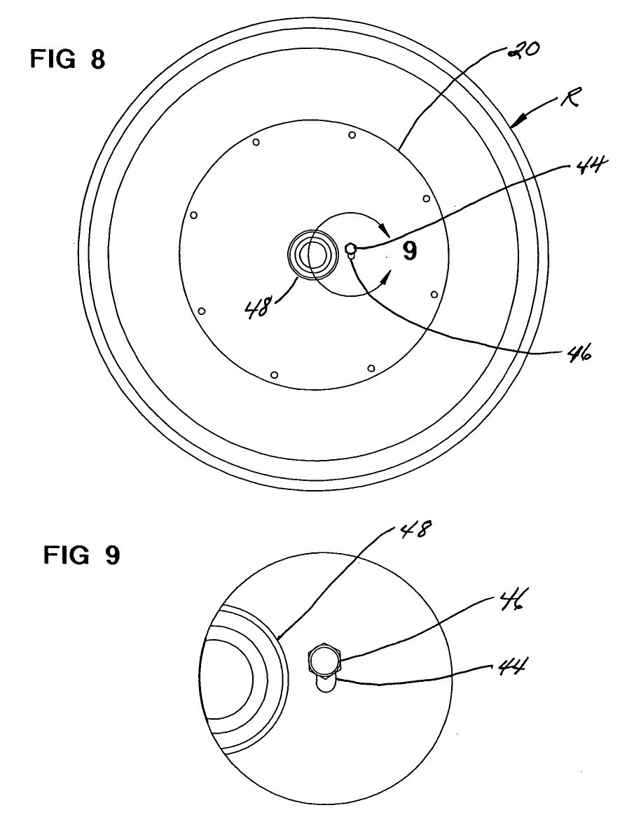

Referring now to the drawings, and particularly to FIGS. 1 to 9, one broad aspect of the invention is there shown generally at numeral 10 in FIG. 1. This aspect 10 of the invention includes an adapter plate 12 which supports a bearing arrangement 16 connected in coaxial alignment with a bearing support hub 28 of the adapter plate 12. This aspect 10 also includes a retainer 18 which is supported over the hub 28 and held from relative rotation by a retainer plate 20.

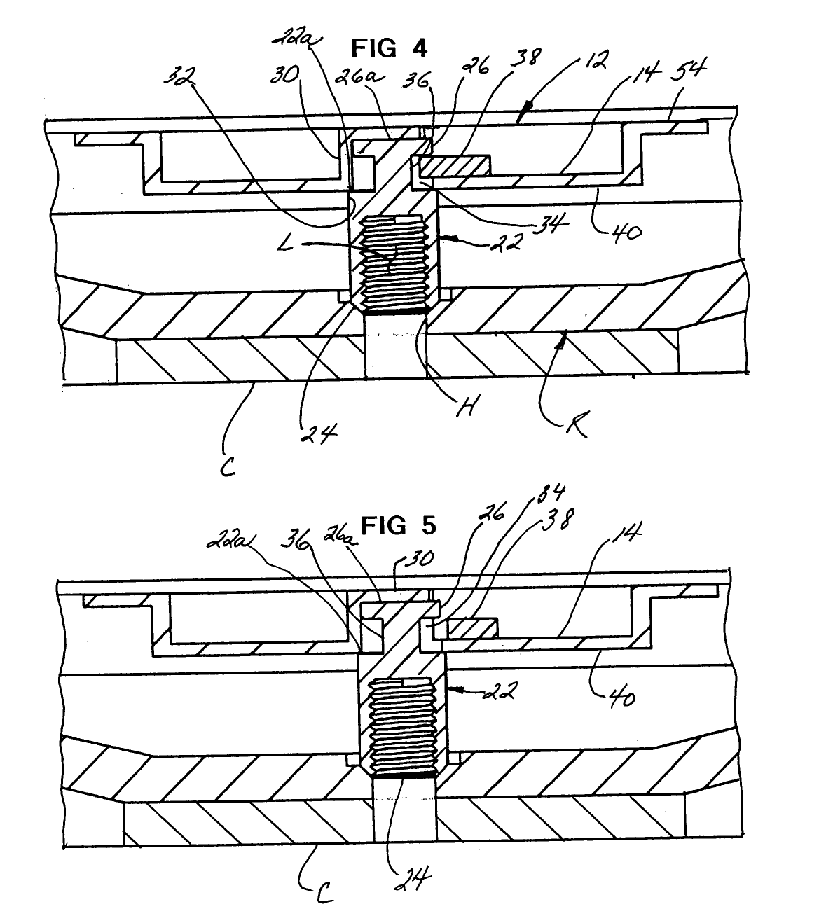

Attachment of the adapter plate 12 to a rim R of a wheel for a vehicle about the axle center line D is effected through the use of a uniquely configured lug nut 22. As best seen in FIGS. 4 and 5, each of the lug nuts 22 is threadably adapted at a first end thereof 24 to threadably engage over a lug L anchored into the axle C which passes through each wheel mounting hole H of the rim R. For economy, it is preferred that at least three of these uniquely configured lug nuts 22 be utilized to attach the rim R to the axle C. The remaining conventional lug nuts (not shown) may be utilized to further secure the rim R to the axle C. The opposite or distal end of each of the lug nuts 22 includes a groove 26 radially inwardly extending as shown to define a head H, the purposes of which will be described herebelow.

The adapter plate 12 includes a central dish-shaped area 14 supporting the hub 28 which supports the bearing arrangement 16 as previously described. A mounting flange 54, offset and radially extending from the central area 14, has threaded mounting holes 52 which provide the attaching means through aligned holes 50 adjacent the periphery of retainer plate 20 by conventional threaded fasteners (not shown for clarity).

Also disposed on the central area 14 is a plurality of apertures 32 each having a partial cover 30 defining an interior cavity 34 associated therewith. The diameter of the mounting apertures 32 is sized for close snug fitting over the distal head 26 of each of the lug nuts 22. The cylindrical cavity 34 is also similarly sized as a uniform extension of mounting aperture 32 to receive the head 26 as best seen in FIGS. 4 and 5. The distal end surface 26a of each of the heads 26 abuts against the bottom of the cavity 34 and against the inner surface of the cover 30. Note that shoulder 22a of each of the lugs nuts 22 also bears against the inner surface of each of the mounting apertures 32 for added support and arcuate positioning of the groove 36 with respect to the outer surface of central area 14 for the purposes described herebelow.

The retainer 18 receives support for rotation by the close sliding alignment of the central aperture 56 over hub 28. The retainer plate 20 is, as previously described, attached to the outer flange 54 of the adapter plate 12 by threaded fasteners through aligned holes 50 and 52. The retainer 18 is attached at threaded cavity 42 to the retainer plate 20 by a threaded fastener 44 fitted through elongated slot 46 of the retainer plate 20. As will be described herebelow, the retainer 18 is thus held for very limited rotational movement about axis D when fastener 44 is loosened as limited by the elongated slot 46, the purposes of which will be described herebelow.

The retainer 18 also includes a plurality of spaced radially extending locking tabs or fingers 38 which are laterally offset from the central portion 40 of the retainer 18. Tabs or fingers 38 are spaced rotationally about axis D to be identical to (or matching) the rotational spacing of each of the mounting apertures 32 and corresponding lug nuts 22. Again, for economy, only three such combinations of lug nuts 22, mounting apertures 32 and fingers or tabs 38 are provided as being deemed sufficient for attachment of this entire arrangement 10 to the rim R as previously described.

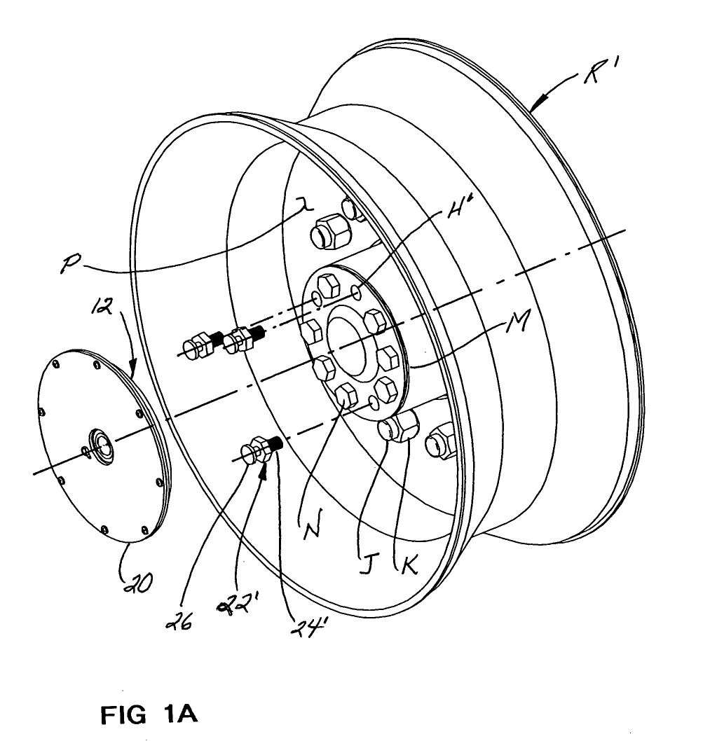

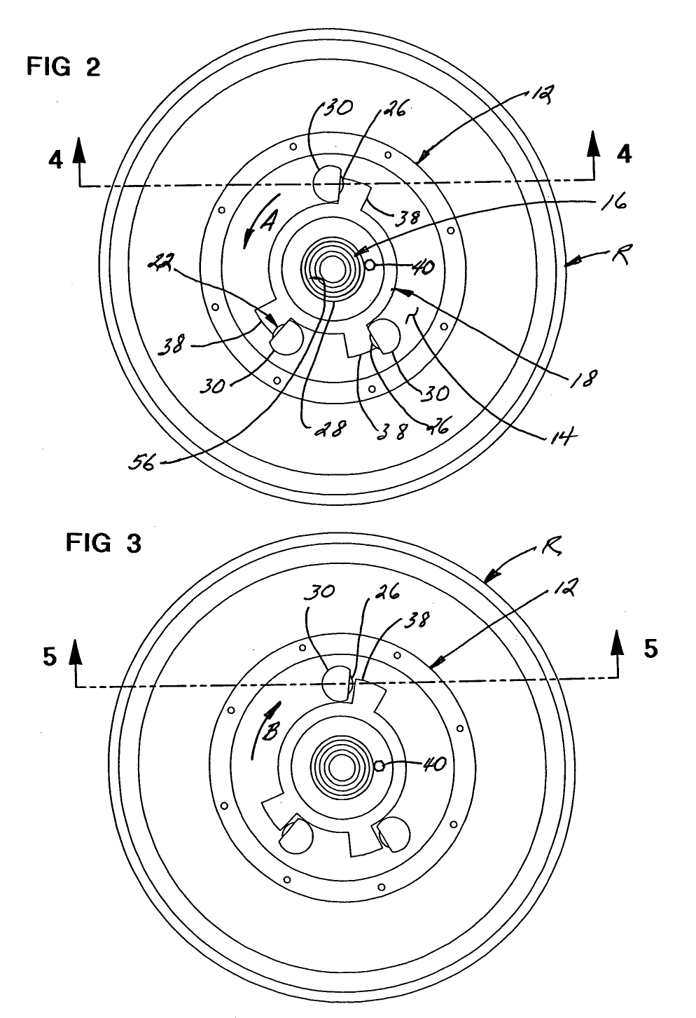

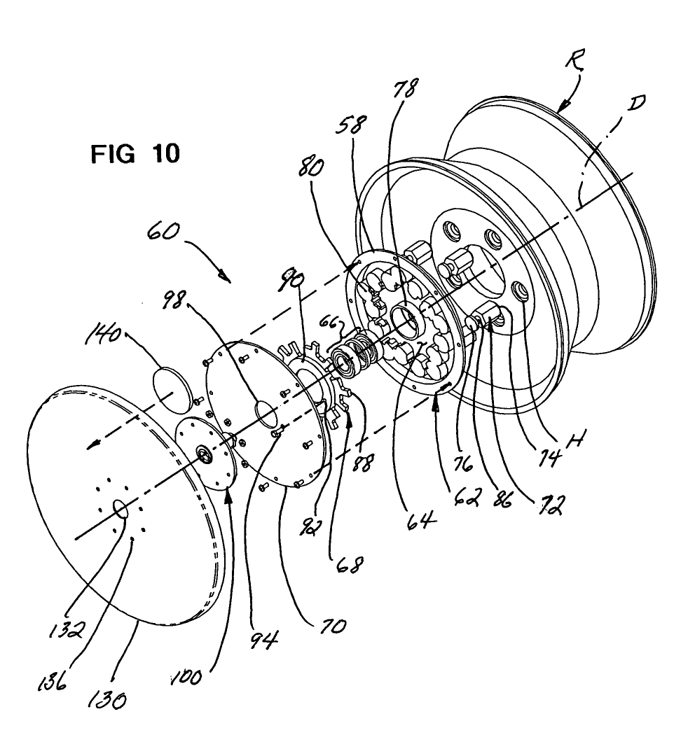

With this arrangement 10 assembled onto the rim R as previously described, the retainer 18 may be rotated about axis D only very limited amount as permitted by slot 46 when the threaded fastener 44 is loosened. Movement of this retainer 18 is between an unlocked and a locked position with respect to the retention or release of the adapter plate 12 with respect to the lug nuts 22 and the heads 26 thereof. As seen in FIGS. 2, 4, 8 and 9, when the threaded fastener 46 is tightened after limited rotational movement of the retainer 18 in the direction of arrow A in FIG. 2, the locked position of the retainer 18 is established. In this orientation, each of the tabs or fingers 38 are positioned into the grooves 36 to prevent any axial movement of the adapter plate 12 with respect to the lug nuts 22. In this locked orientation of the adapter plate 12, the additional components of the entire system (described herebelow) including the wheel cover locking support 100 and the wheel cover 130 itself as shown in FIG. 10, which bears the advertising or viewable indicia which remains stationary during vehicle movement, may then be attached as described herebelow.

To release or unlock the adapter plate 12 from the lug nuts 22, threaded fastener 44 is simply loosened and then may be utilized to rotate the retainer 18 in the direction of arrow B in FIG. 3 to disengage each of the fingers or tabs 38 from the corresponding grooves 36. Note that the partial covers 30 partially surrounding each of the mounting apertures 32 also provide a relative degree of protection from dirt accumulation in this critical engagement area between the heads 26 and corresponding grooves 36, mounting apertures 32 and locking tabs or fingers 38.

Referring now to FIG. 1A, a rear axle flange M associated with large trucks and busses is assembled together by lugs N through mating apertures H′ which are separate from the lugs J and lug nuts K which attached the rim R′ to the axle of the truck or bus. The larger bolt circle for the wheel mounting lugs J and lug buts K are formed into the central web P of the rim R′ as shown.

To accommodate this axle hub M arrangement, a shortened elongated attaching lug 22′ is provided. This attaching lug 22′ has a first end 24′ which is threaded similar to lug N and is threadable into the threaded cavities H′ of the axle hub M. Typically, there are eight or ten such lugs N utilized to assemble the axle hub M and it is thus preferred to replace only a portion (typically three) of those standard lugs N by the attaching lugs 32′ to provide adequate strength. As previously described, after the attaching lugs 22′ are installed into the portion of the threaded holes H′, the hreaded opposite ends 26 of the attaching lugs 22′ are passed through the mounting holes 32 and thereafter, into locking engagement within cavities 34.

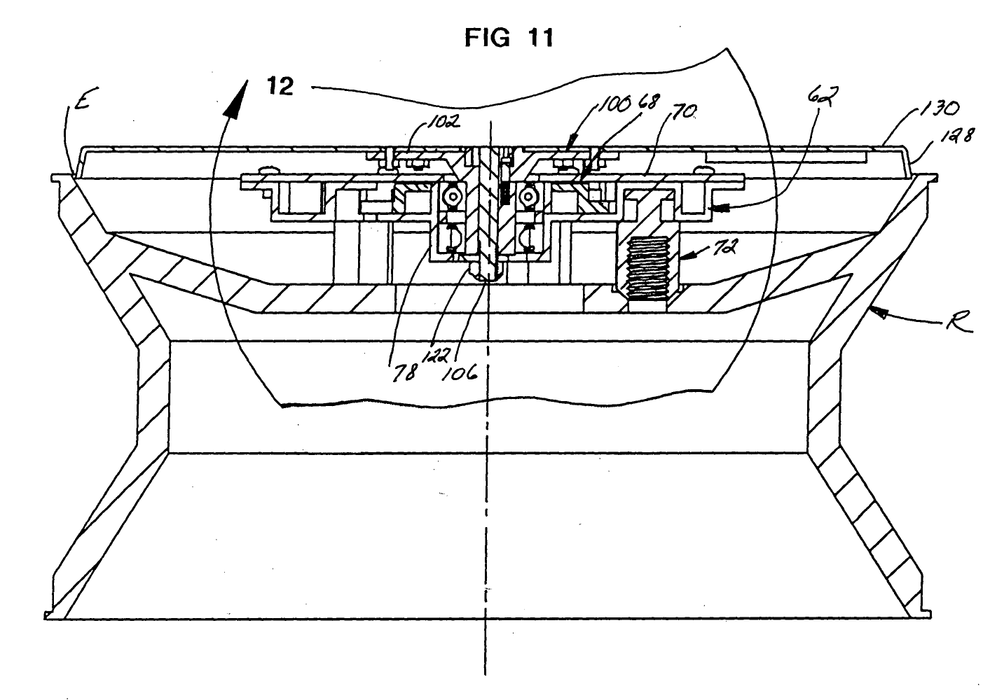

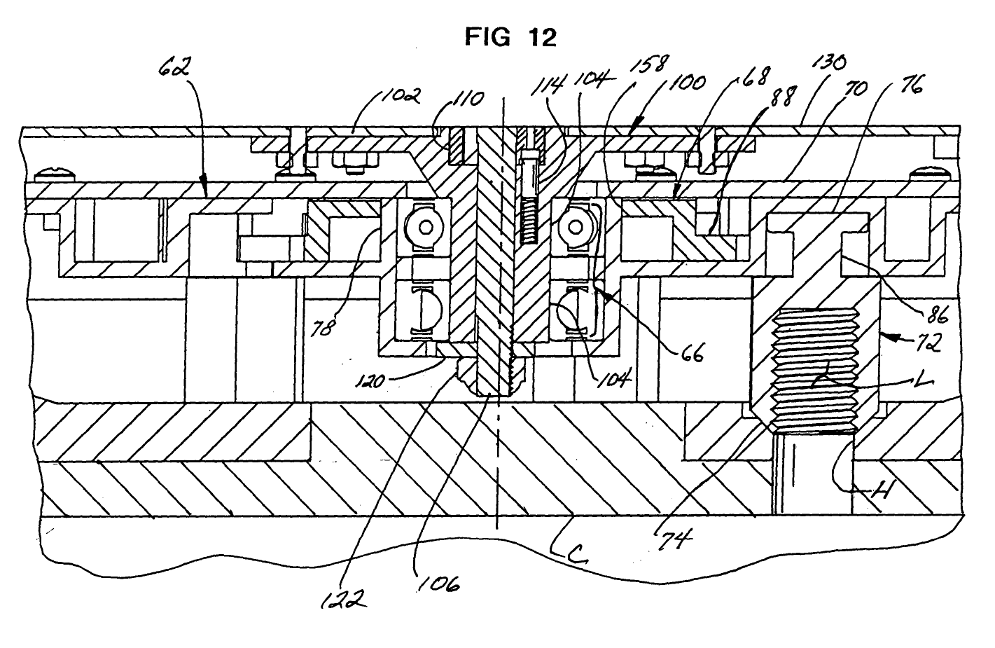

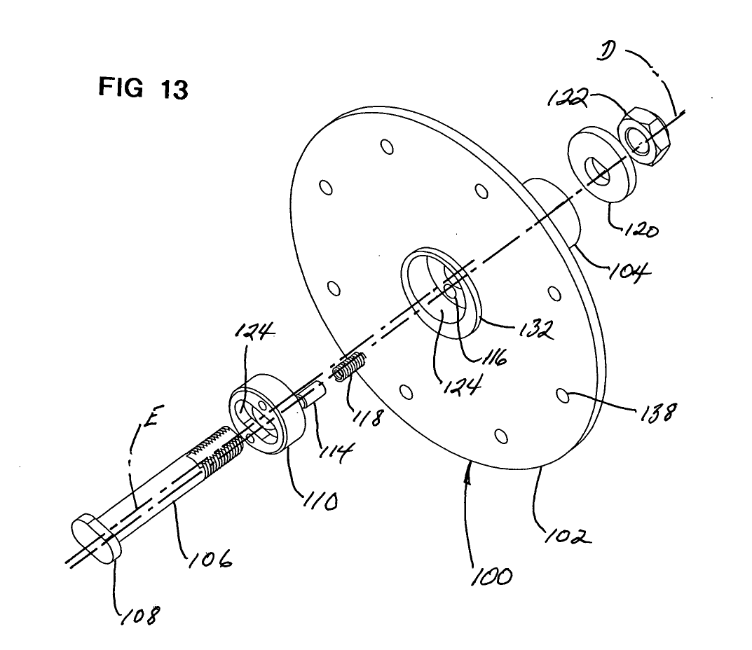

Once the adapter plate 12 is lockingly secured to the lug nuts 22 by the retainer 18 and retainer plate 20, the outer commercial display wheel cover 130 as seen in FIGS. 10 to 12, may then be installed. The wheel cover locking support 100, as shown in detail in FIGS. 13 to 18, is provided to effect installation of the wheel cover 130. The wheel cover locking support 100 includes an elongated support shaft 104 and an enlarged orthogonally extending mounting flange 102 having threaded attaching apertures 138 which are aligned with apertures 136 of the wheel cover 130 as seen in FIG. 10. The outer cylindrical surface of the support shaft 104 is closely aligned for snug close sliding insertion into the inside diameter of the bearing arrangement 16 in FIG. 1 and 66 in FIG. 10. By this arrangement, the support shaft 104 with the wheel cover 130 rigidly attached to flange 102, is slidably supportively engageable into the bearing arrangement 16 or 66.

The locking or anti-theft features of this invention include an elongated locking member 106 which snugly and slidably engages for rotation within an elongated aperture or passageway formed longitudinally through the support shaft 104. Note importantly that the separate axis E of the elongated locking member 106 and mating passageway are offset and parallel to the longitudinal axis D which is concentric with the outer cylindrical surface of the support member 104, the rim R and the vehicle axle.

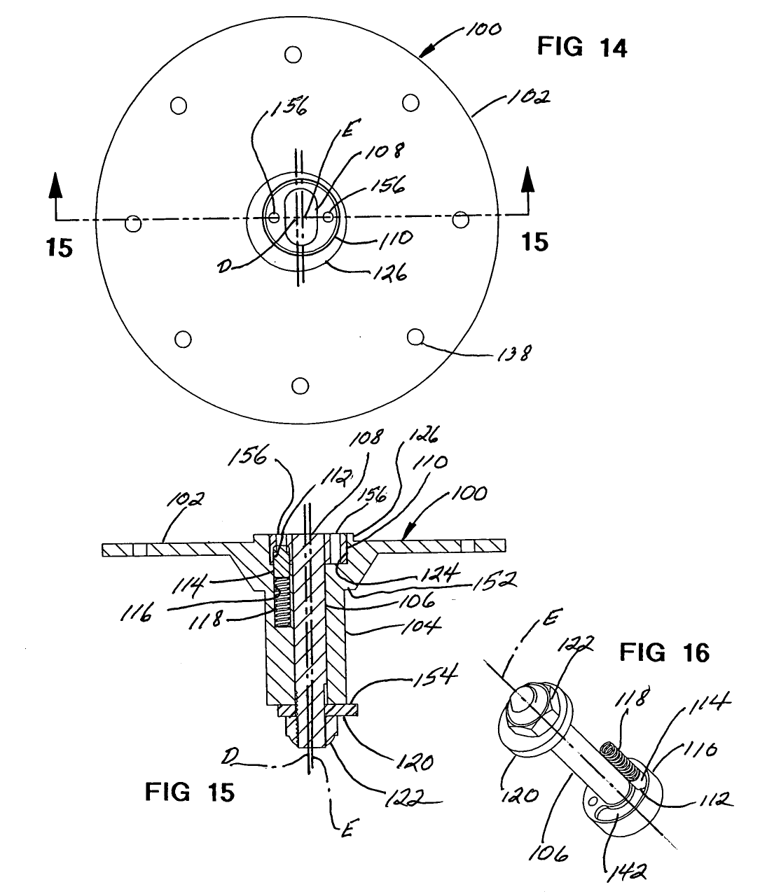

A cam member 120 is mechanically attached by a threaded nut 122 onto the distal end of the support shaft 104. A detent plunger 114 is biased by spring 118 to act within an arcuate cavity 142 of actuator 110 which is engaged over the head 108 within mating cavity 124 of locking support 100. Relative axial rotation of the support shaft 104 is thus limited by the sliding movement of the detent plunger 114 within the arcuate cavity 142. When in the position shown in FIGS. 14 to 16, the detent plunger 114 is urged into a locking cavity 112 formed at one end of the arcuate groove 142. This locked position coincides with the cam member 120 being misaligned at 154 as best seen in FIG. 15 with the outer cylindrical surface of the support shaft 36. This establishes the locked position of the cam member 120 wherein shoulder 152 and surface 154 precisely straddle and mate against the outer end surfaces of the bearing arrangement 16 or 66.

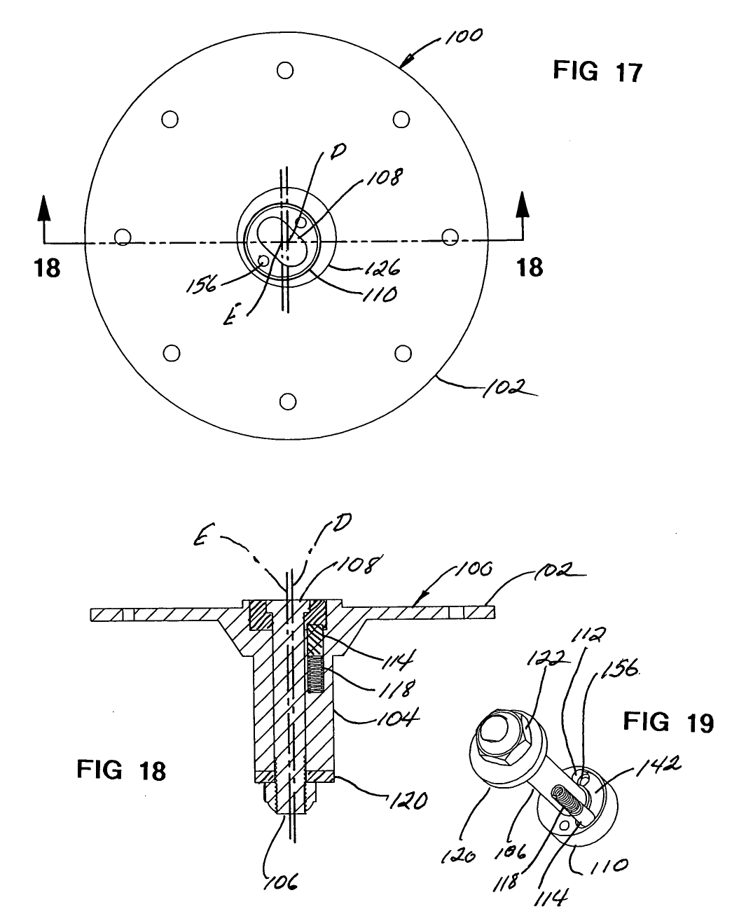

When the locking member 106 is rotated into the position shown in FIGS. 17 to 19 wherein the plunger 114 moves out of the locking cavity 112 to the opposite end of the arcuate cavity 142, the cam member 120 is precisely aligned with the cylindrical outer surface of the support member 104 whereupon the wheel cover locking support 100 may be slidably withdrawn axially from engagement within the bearing arrangement 16 or 66.

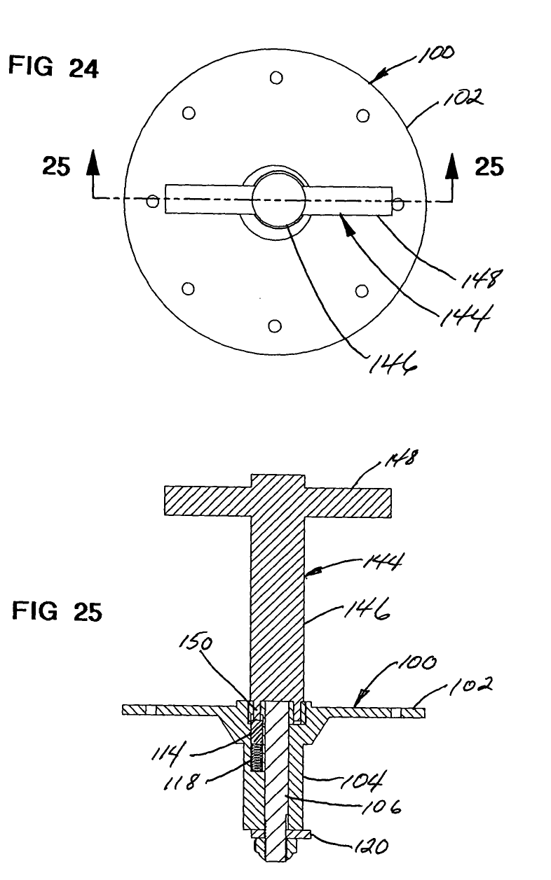

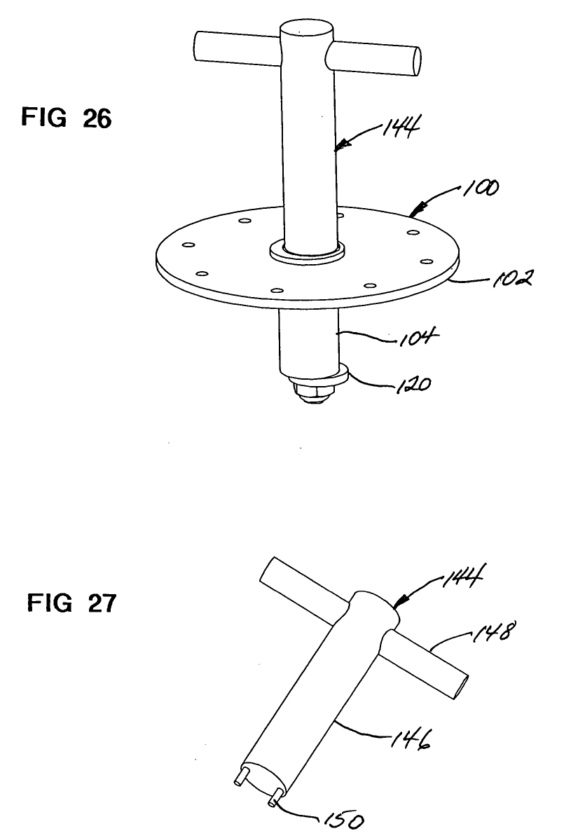

Referring additionally to FIGS. 24 to 27, a locking key 144 is there shown. This locking key 144, which includes a longitudinal body 146 and a handle 148, is shown engaged within mating cavities 156 of the adapter 110. One of the pins 150 is shown inserted into one of these cavities 156 which is aligned with locking detent cavity 112, while the other cavity receives the other drive pin 150 to effect rotation of the locking member 106. By insertion of the pins 150 into these cavities 156 when the locking member 106 is in the locked position shown in FIGS. 14 to 16, the detent plunger 114 is forced to withdraw against biased spring pressure from spring 118 from detent cavity 112 a distance sufficient to then allow rotation of the locking member 106 and the sliding movement of the detent plunger 114 along the arcuate cavity 142 to effect unlocking and removal of the wheel cover locking support 100 as previously described.

Referring now to FIGS. 10 to 12 and 20A to 23, a universal embodiment of the invention is there shown generally at numeral 60 in FIG. 10. The majority of the components, including the rim R, each of the lug nuts 72 except with respect to overall length as compared to lug nut 22, the bearing arrangement 66 which is substantially identical to the bearing arrangement 16 previously described, and retainer plate 70 which is structured for attachment to the flange 58 of the universal adapter plate 62 (described herebelow) are as previously described. Likewise, the same wheel cover locking support 100 and wheel cover 130 having an adaptive outer surface for receiving printed indicia such as in the form of advertising display material are included in this embodiment 60.

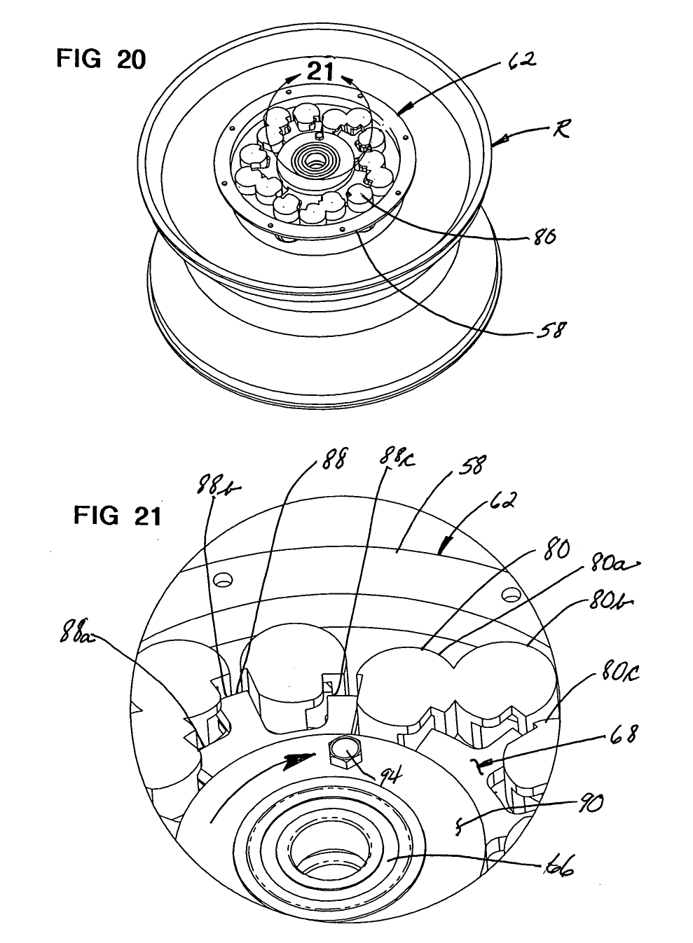

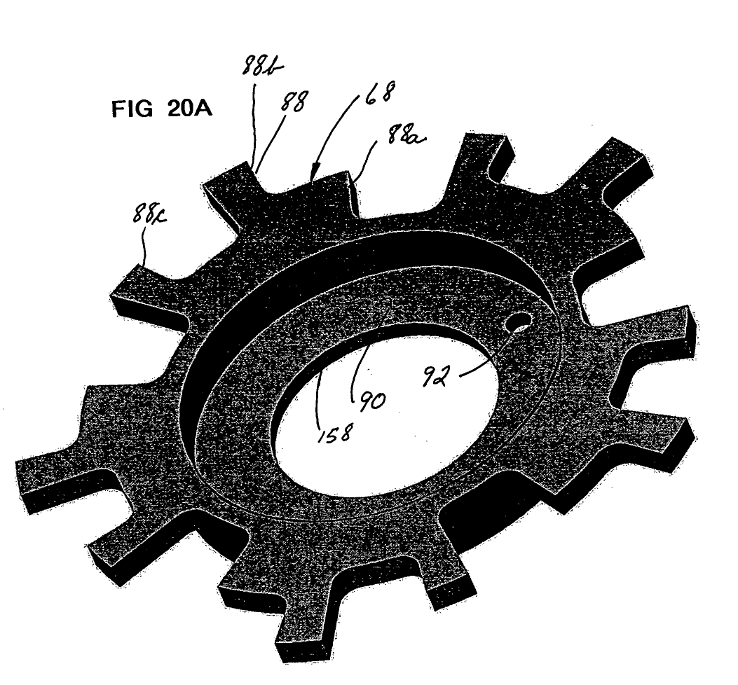

The distinctive aspect of this embodiment 60 surrounds the universal adapter plate 62 and the associated universal retainer 68 as best seen in FIG. 20A. In this embodiment 60, the special multi-task lug nuts 72 as previously described, having a groove 86 and head 76 at the distal end thereof, are threadably engaged onto all of the lugs L provided with the axle of the vehicle through mounting holes H in the rim R. However, there are several axle stud and rim mounting hole H patterns of different bolt circle diameters and spacing, and even differences in the overall number of lugs provided for supporting the rim R. To accommodate a plurality of the more popular bolt patterns for mounting the rim R, the universal retainer 68 shown in FIG. 20A is provided.

This universal retainer 68 includes the disc-shaped central portion 90 having mounting aperture 92 which aligns with the threaded fastener 94 within a slotted hole formed into the retainer plate 70 as previously described. Likewise, the central hole 158 is sized to slidably receive and be supported on the central neck 78 of the universal adapter plate 62. However, this retainer 68 is provided with locking lugs or tabs 88 each of which include three separate tabs locking edge portions 88a, 88b and 88c in five separate evenly spaced arrays to match the bolt circle pattern shown in FIG. 10 and for engagement with all five of the lug nuts 72.

As best seen in FIGS. 20 to 23, the universal adapter plate 62 also provides five separate clusters of three mounting apertures (not shown) formed through the central portion 64 which are sized to snugly receive the heads 76 of each of the lug nuts 72. Each of these five groups of three mounting apertures has a partial cover 80 which includes cover portions 80a, 80b and 80c. Each of these cover portions 80a, 80b and 80c provide a cylindrical interior surface which mates and is continuous with each of the mounting apertures as previously described with respect to the embodiment 12 previously described for proper stable positioning over each head 76.

As seen in FIGS. 20 and 21, when the universal adapter plate 62 is rotated in the direction of the arrow as limited by the loosened threaded fastener 94, each of the locking tab portions 88a, 88b and 88c become disengaged from the corresponding grooves 86 within each of the lug nuts 72. In this unlocked configuration, the universal adapter plate 62 is removable from the lug nuts 72 which then may be tightened to required specifications or removed for tire replacement.

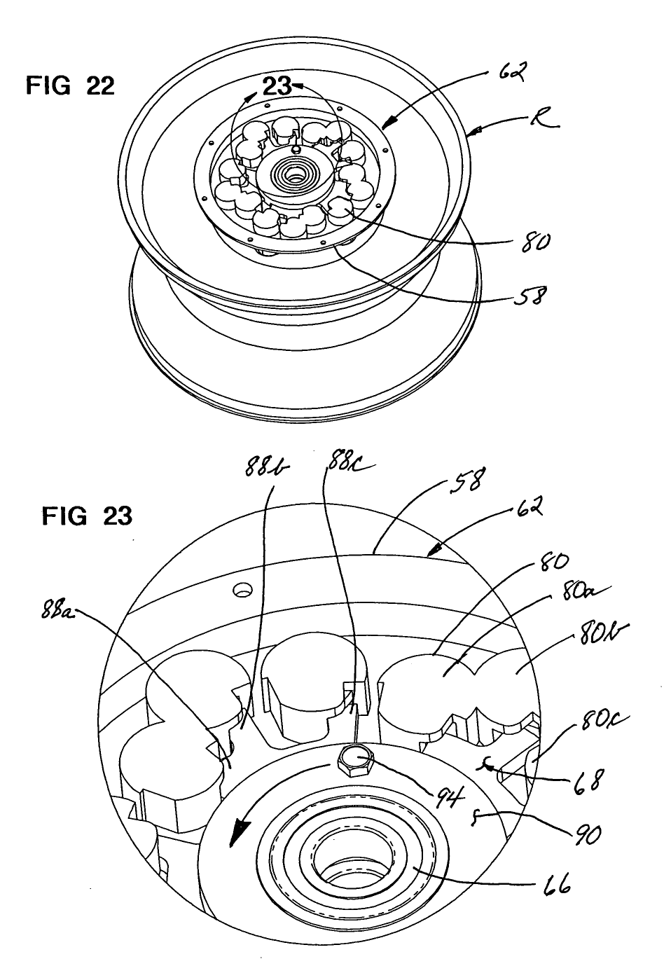

In the locked position shown in FIGS. 22 and 23, the universal adapter plate 62 has been rotated in the opposite direction of that arrow as limited by the threaded fastener 94 as previously described. In this locked configuration, each of the locking tab portions 88a, 88b and 88c are engaged into the corresponding groove 86 of each of the lug nuts 72, whereupon the threaded fastener 94 is tightened and secured to maintain this locked and assembled deployment of the universal adapter plate 62, retainer 68 and retainer plate 70 (not shown in these figures) during vehicle use.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

1. A non-rotating display wheel cover assembly connectable to a rotatable wheel and supporting axle of a vehicle comprising:
an adapter plate including a support bearing member concentrically positioned and supported by a support bearing hub of said adapter plate which also has mounting apertures adapted to align with threaded lugs rigidly attached to, and extending from, the axle in substantially coaxial alignment with a rotational axis of the wheel and axle;
a plurality of elongated wheel attaching lug nuts each threadably engagable from a first end thereof onto one of the wheel lugs which, when extended through aligned wheel mounting holes of the wheel, thereby rigidly connecting the wheel to the axle;
a distal second end of each of said lug nuts having an inwardly extending groove formed adjacent said second end and being sized for insertion through one of said mounting apertures of said adapter plate;
a retainer supported for limited substantially coaxial rotation only on said support bearing hub with respect to said adapter plate and between locked and unlocked positions, said retainer including radially extending spaced apart locking fingers or tabs each of which is sized in thickness and length to engage into a corresponding said groove of one said lug nut when said retainer is rotated into the locked position whereby said retainer and said adapter plate are secured to said lug nuts and to the wheel, said retainer and said adapter plate being removable from said lug nuts for servicing said lug nuts or wheel removal when said retainer is in the unlocked position;
a circular wheel cover including a wheel cover locking support having a support shaft extending concentrically and orthogonally from an inside surface of said wheel cover, said support shaft supported for rotation in coaxial alignment, when fully engaged, with said support bearing member;
said wheel cover locking support including an elongated locking member having a distal end and an enlarged proximal end and held for rotation within, and substantially coextensive with, a longitudinal aperture formed through said support shaft;
a cam member connected to a distal end of, and rotatable with, said locking member, said cam member having a non-symmetric periphery with respect to a rotational axis of said locking member and having a first rotational orientation with respect to said support shaft wherein said support shaft and said locking member are fully insertable as a unit into said support bearing member to effect full attachment between said inner member and said wheel cover and a second rotational orientation wherein, after said support shaft and said locking member are fully inserted into said support bearing, said cam member prevents withdrawal of said support shaft from said support bearing member, thus locking said inner member and said wheel cover together for relative rotation only therebetween;
a counterweight attached to said wheel cover to substantially prevent rotation of said wheel cover with respect to the vehicle as the wheel is rotated during vehicle movement whereby an interchangeable display indicia attached to an outer surface of said wheel cover remains substantially upright and readable during vehicle movement.

2. A non-rotating display wheel cover assembly connectable to a rotatable wheel and supporting axle of a vehicle comprising:
an adapter plate including a support bearing member concentrically positioned and supported by a support bearing hub of said adapter plate which also has mounting apertures adapted to align with threaded lugs rigidly attached to, and extending from, the axle in substantially coaxial alignment with a rotational axis of the wheel and axle;
a plurality of elongated wheel attaching lug nuts each threadably engagable from a first end thereof onto one of the wheel lugs which, when extended through aligned wheel mounting holes of the wheel, thereby rigidly connecting the wheel to the axle;
a distal second end of each of said lug nuts having an inwardly extending groove formed adjacent said second end and being sized for insertion through one of said mounting apertures of said adapter plate, a shoulder of each said groove being larger than, and breaking against an edge portion of, said mounting aperture;
a retainer supported for limited substantially coaxial rotation only on said support bearing hub with respect to said adapter plate, said retainer including radially extending spaced apart locking fingers or tabs each of which is sized in thickness and length to engage into a corresponding said groove of one said lug nut after said distal ends of each said lug nuts are passed through corresponding said mounting apertures when said retainer is rotated in one direction into a locked position whereby said retainer and said adapter plate are secured from substantial movement to said lug nuts and to the wheel, said retainer and said adapter plate being removable from said lug nuts for servicing said lug nuts or wheel removal when said retainer is rotated in an opposite direction to an unlocked position;
a circular wheel cover including a wheel cover locking support having a support shaft extending concentrically and orthogonally from an inside surface of said wheel cover, said support shaft supported for rotation in coaxial alignment, when fully engaged, with said support bearing member;
an elongated releasable locking member for releasably locking said adapter plate and said wheel cover together in spaced apart relation one to another for relative rotation only therebetween;
a counterweight attached to said wheel cover to substantially prevent rotation of said wheel cover with respect to the vehicle as the wheel is rotated during vehicle movement whereby an interchangeable display indicia attached to an outer surface of said wheel cover remains substantially upright and readable during vehicle movement.

3. A non-rotating display wheel cover assembly connectable to a rotatable wheel and supporting axle of a plurality of vehicles, each vehicle having a different wheel mounting lug pattern, comprising:
a universal adapter plate including a support bearing member concentrically positioned and supported by a support bearing hub of said adapter plate which also has mounting apertures adapted to align with threaded lugs of each of the lug patterns of each vehicle and being rigidly attached to, and extending from, the axle of each vehicle in substantially coaxial alignment with a rotational axis of the wheel and axle;
said adapter plate having a partially enclosing cavity open on one side thereof formed over each of said mounting apertures;
a plurality of elongated wheel attaching lug nuts each threadably engagable from a first end thereof onto one of the wheel lugs which, when extended through one of the patterns of aligned wheel mounting holes of the wheel, thereby rigidly connecting the wheel to the axle;
a distal second end of each of said lug nuts having an inwardly extending groove formed adjacent said second end and defining a distal head portion sized for closely aligned insertion through one of said mounting apertures of said adapter plate;
an interior side surface of each said cavity substantially continuous with said mounting apertures for supportingly receiving said distal head portions, a distal end surface of each said distal head portion bearing against a bottom surface of said cavity to properly position said grooves in said mounting apertures;
a retainer supported for limited substantially coaxial rotation only on said support bearing hub with respect to said adapter plate and between locked and unlocked positions, said retainer including radially extending spaced apart locking fingers or tabs each of which is sized in thickness and length to engage into said open sides of said cavity and into said groove of one said lug nut when said retainer is rotated into the locked position whereby said retainer and said adapter plate are secured to said lug nuts and to the wheel, said retainer and said adapter plate being removable from said lug nuts for servicing said lug nuts or wheel removal when said retainer is in the unlocked position;
a circular wheel cover including a wheel cover locking support having a support shaft extending concentrically and orthogonally from an inside surface of said wheel cover, said support shaft supported for rotation in coaxial alignment, when fully engaged, with said support bearing member;
said wheel cover locking support including an elongated locking member having a distal end and an enlarged proximal end and held for rotation within, and substantially coextensive with, a longitudinal aperture formed through said support shaft;
a cam member connected to a distal end of, and rotatable with, said locking member, said cam member having a non-symmetric periphery with respect to a rotational axis of said locking member and having a first rotational orientation with respect to said support shaft wherein said support shaft and said locking member are fully insertable as a unit into said support bearing member to effect full attachment between said inner member and said wheel cover and a second rotational orientation wherein, after said support shaft and said locking member are fully inserted into said support bearing, said cam member prevents withdrawal of said support shaft from said support bearing member, thus locking said inner member and said wheel cover together for relative rotation only therebetween;
a counterweight attached to said wheel cover to substantially prevent rotation of said wheel cover with respect to the vehicle as the wheel is rotated during vehicle movement whereby an interchangeable display indicia attached to an outer surface of said wheel cover remains substantially upright and readable during vehicle movement.

4. A non-rotating display wheel cover assembly connectable to a rotatable wheel and supporting axle of a plurality of vehicles, each vehicle having a different wheel mounting lug pattern, comprising:
a universal adapter plate including a support bearing member concentrically positioned and supported by a support bearing hub of said adapter plate which also has mounting apertures adapted to align with threaded lugs of each of the lug patterns of each vehicle and being rigidly attached to, and extending from, the axle of each vehicle in substantially coaxial alignment with a rotational axis of the wheel and axle;
said adapter plate having a partially enclosing cavity open on one side thereof formed over each of said mounting apertures;
a plurality of elongated wheel attaching lug nuts each threadably engagable from a first end thereof onto one of the wheel lugs which, when extended through one of the patterns of aligned wheel mounting holes of the wheel, thereby rigidly connecting the wheel to the axle;
a distal second end of each of said lug nuts having an inwardly extending groove formed adjacent said second end and defining a distal head portion sized for closely aligned insertion through one of said mounting apertures of said adapter plate;
an interior side surface of each said cavity substantially continuous with said mounting apertures for supportingly receiving said distal head portions, a distal end surface of each said distal head portion bearing against a bottom surface of said cavity to properly position said grooves in said mounting apertures;
a retainer supported for limited substantially coaxial rotation only on said support bearing hub with respect to said adapter plate and between locked and unlocked positions, said retainer including radially extending spaced apart locking fingers or tabs each of which is sized in thickness and length to engage into said open sides of said cavity and into said groove of one said lug nut when said retainer is rotated into the locked position whereby said retainer and said adapter plate are secured to said lug nuts and to the wheel, said retainer and said adapter plate being removable from said lug nuts for servicing said lug nuts or wheel removal when said retainer is in the unlocked position;
a circular wheel cover including a wheel cover locking support having a support shaft extending concentrically and orthogonally from an inside surface of said wheel cover, said support shaft supported for rotation in coaxial alignment, when fully engaged, with said support bearing member;
an elongated releasable locking member for releasably locking said adapter plate and said wheel cover together in spaced apart relation one to another for relative rotation only therebetween;
a counterweight attached to said wheel cover to substantially prevent rotation of said wheel cover with respect to the vehicle as the wheel is rotated during vehicle movement whereby an interchangeable display indicia attached to an outer surface of said wheel cover remains substantially upright and readable during vehicle movement.

5. For a non-rotating display wheel cover assembly having a circular wheel cover and a wheel cover locking support, the wheel cover assembly supported by a rotatable wheel and supporting axle of a vehicle a quick-release assembly operatively positioned between and attachable to a wheel rim and the wheel cover assembly, comprising:
an adapter plate including a support bearing member concentrically positioned and supported by a support bearing hub of said adapter plate which also has mounting apertures adapted to align with threaded lugs rigidly attached to, and extending from, the axle in substantially coaxial alignment with a rotational axis of the wheel and axle;
a plurality of elongated wheel attaching lug nuts each threadably engagable from a first end thereof onto one of the wheel lugs which, when extended through aligned wheel mounting holes of the wheel, thereby rigidly connecting the wheel to the axle;
a distal second end of each of said lug nuts having an inwardly extending groove formed adjacent said second end and being sized for insertion through one of said mounting apertures of said adapter plate, a shoulder of each said groove being larger than, and breaking against an edge portion of, said mounting aperture;
a retainer supported for limited substantially coaxial rotation only on said support bearing hub with respect to said adapter plate, said retainer including radially extending spaced apart locking fingers or tabs each of which is sized in thickness and length to engage into a corresponding said groove of one said lug nut after said distal ends of each said lug nuts are passed through corresponding said mounting apertures when said retainer is rotated in one direction into a locked position whereby said retainer and said adapter plate are secured from substantial movement to said lug nuts and to the wheel, said retainer and said adapter plate being removable from said lug nuts for servicing said lug nuts or wheel removal when said retainer is rotated in an opposite direction to an unlocked position;
a support shaft of the wheel cover locking support extending concentrically and orthogonally from an inside surface of the wheel cover into and being supported for rotation within said support bearing member and being retained thusly by a releasable locking member of the display wheel cover assembly for relative rotation only therebetween.

6. A non-rotating display wheel cover assembly connectable to a rotatable wheel and supporting axle of a vehicle comprising:
an adapter plate including a support bearing member concentrically positioned and supported by a support bearing hub of said adapter plate which also has mounting apertures adapted to align with threaded lugs rigidly attached to, and extending from, the axle in substantially coaxial alignment with a rotational axis of the wheel and axle;
a plurality of elongated wheel attaching lug nuts each threadably engagable from a first end thereof into one of the threaded axle hub holes;
a distal second end of each of said lug nuts having an inwardly extending groove formed adjacent said second end and being sized for insertion through one of said mounting apertures of said adapter plate, a shoulder of each said groove being larger than, and breaking against an edge portion of, said mounting aperture;
a retainer supported for limited substantially coaxial rotation only on said support bearing hub with respect to said adapter plate, said retainer including radially extending spaced apart locking fingers or tabs each of which is sized in thickness and length to engage into a corresponding said groove of one said lug nut after said distal ends of each said lug nuts are passed through corresponding said mounting apertures when said retainer is rotated in one direction into a locked position whereby said retainer and said adapter plate are secured from substantial movement to said lug nuts and to the wheel, said retainer and said adapter plate being removable from said lug nuts for servicing said lug nuts or wheel removal when said retainer is rotated in an opposite direction to an unlocked position;
a circular wheel cover including a wheel cover locking support having a support shaft extending concentrically and orthogonally from an inside surface of said wheel cover, said support shaft supported for rotation in coaxial alignment, when fully engaged, with said support bearing member;
an elongated releasable locking member for releasably locking said adapter plate and said wheel cover together in spaced apart relation one to another for relative rotation only therebetween;
a counterweight attached to said wheel cover to substantially prevent rotation of said wheel cover with respect to the vehicle as the wheel is rotated during vehicle movement whereby an interchangeable display indicia attached to an outer surface of said wheel cover remains substantially upright and readable during vehicle movement.
